(19) United States
(12) Patent Application Publication
(10) Pub. No.: US 2026/0073223 A1
(43) Pub. Date: Mar. 12, 2026

(54) METHOD FOR CONTROLLING VIDEO MEMORY FOR MODEL TRAINING, ELECTRONIC DEVICE AND STORAGE MEDIUM

(71) Applicant: Beijing Baidu Netcom Science Technology Co., Ltd., Beijing (CN)

(72) Inventors: Jinle Zeng, Beijing (CN); Liang Shen, Beijing (CN); Jiabin Yang, Beijing (CN); Dianhai Yu, Beijing (CN); Yanjun Ma, Beijing (CN); Haifeng Wang, Beijing (CN)

(73) Assignee: Beijing Baidu Netcom Science Technology Co., Ltd., Beijing (CN)

(21) Appl. No.: 19/242,599

(22) Filed: Jun. 18, 2025

(30) Foreign Application Priority Data
Dec. 17, 2024 (CN) 202411865996.2

(51) Int. Cl. G06N 3/084

(52) U.S. Cl. CPC G06N 3/084

(57) ABSTRACT

A method for controlling a video memory for model training, an electronic device and a storage medium are provided, relating to the field of artificial intelligence technology, and in particular to the fields of neural network, large model, training optimization and other technologies. The method includes: reconstructing a video memory space for one or more backward calculations during model training according to grouping information of parameter gradient information required for the one or more backward calculations; performing the one or more backward calculations to obtain one or more backward calculation results; storing the one or more backward calculation results into the video memory space reconstructed for the one or more backward calculations; and releasing the video memory space reconstructed for the one or more backward calculations.

### CROSS-REFERENCE TO RELATED APPLICATIONS

The present application claims priority to Chinese Patent Application No. CN202411865996.2, filed with the China National Intellectual Property Administration on Dec. 17, 2024, the disclosure of which is hereby incorporated herein by reference in its entirety.

### TECHNICAL FIELD

The present disclosure relates to the field of artificial intelligence technology, and in particular to the fields of neural network, large model, training optimization and other technologies.

### BACKGROUND

The video memory is very important in training a large model. The large model usually contains a huge number of parameters, and these parameters need to be constantly read, updated and stored during the training process. As the part of the Graphics Processing Unit (GPU) specifically used for storing and processing data, the video memory can provide support for fast storage and access of model parameters, ensuring smooth model training. If the video memory is insufficient, there may be a need to use strategies such as recalculation to save the video memory. However, the recalculation will lead to performance degradation, so other means should be used to save the video memory to reduce or eliminate the recalculation.

### SUMMARY

The present disclosure provides a method and an apparatus for controlling a video memory for model training, a device and a storage medium.

According to one aspect of the present disclosure, provided is a method for controlling a video memory for model training, including:
reconstructing a video memory space for one or more backward calculations according to grouping information of parameter gradient information required for the one or more backward calculations;
performing the one or more backward calculations to obtain one or more backward calculation results;
storing the one or more backward calculation results into the video memory space reconstructed for the one or more backward calculations; and
releasing the video memory space reconstructed for the one or more backward calculations.

According to another aspect of the present disclosure, provided is an apparatus for controlling a video memory for model training, including:
a reconstruction module configured to reconstruct a video memory space for one or more backward calculations according to grouping information of parameter gradient information required for the one or more backward calculations;
a calculation module configured to perform the one or more backward calculations to obtain one or more backward calculation results;
a storage module configured to store the one or more backward calculation results into the video memory space reconstructed for the one or more backward calculations; and
a release module configured to release the video memory space reconstructed for the one or more backward calculations.

According to yet another aspect of the present disclosure, provided is an electronic device, including:
at least one processor; and
a memory connected in communication with the at least one processor;
where the memory stores an instruction executable by the at least one processor, and the instruction, when executed by the at least one processor, enables the at least one processor to execute the method of any embodiment of the present disclosure.

According to yet another aspect of the present disclosure, provided is a non-transitory computer-readable storage medium storing a computer instruction thereon, and the computer instruction is used to cause a computer to execute the method according to any one of the embodiments of the present disclosure.

According to yet another aspect of the present disclosure, provided is a computer program product including a computer program, and the computer program implements the method according to any one of the embodiments of the present disclosure, when executed by a processor.

According to the embodiments of the present disclosure, the video memory space can be reconstructed for the grouping information of the parameter gradient information required for the backward calculation before the backward calculation, and the reconstructed video memory space can be released after the backward calculation ends and the model update is completed, reducing the occupancy of the video memory space during subsequent model training, increasing the recalculation speed, and thus increasing the model training speed.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a schematic flow chart of a method for controlling a video memory for model training according to an embodiment of the present disclosure.

FIG. 2 is a schematic flow chart of a single training step of a method for zeroing a video memory according to the present disclosure.

FIG. 3 is a schematic flow chart of a single training step of the method for controlling the video memory for model training according to the present disclosure.

FIG. 4 is a schematic flow chart of a single training step of the method for controlling the video memory for model training according to the present disclosure.

FIG. 5 is a schematic flow chart of a method for controlling a video memory for model training according to another embodiment of the present disclosure.

FIG. 6 is a schematic flow chart of a method for controlling a video memory for model training according to another embodiment of the present disclosure.

FIG. 7a is a schematic diagram of not releasing the video memory in a single training step of model training.

FIG. 7b is a schematic diagram of releasing the video memory in a single training step of model training.

FIG. 8 is a structural schematic diagram of an apparatus for controlling a video memory for model training according to an embodiment of the present disclosure.

FIG. 9 is a structural schematic diagram of an apparatus for controlling a video memory for model training according to another embodiment of the present disclosure.

FIG. 10 is a block diagram of an electronic device for implementing the embodiments of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope of the present disclosure. Likewise, for clarity and conciseness, descriptions of well-known functions and structures are omitted in the following descriptions.

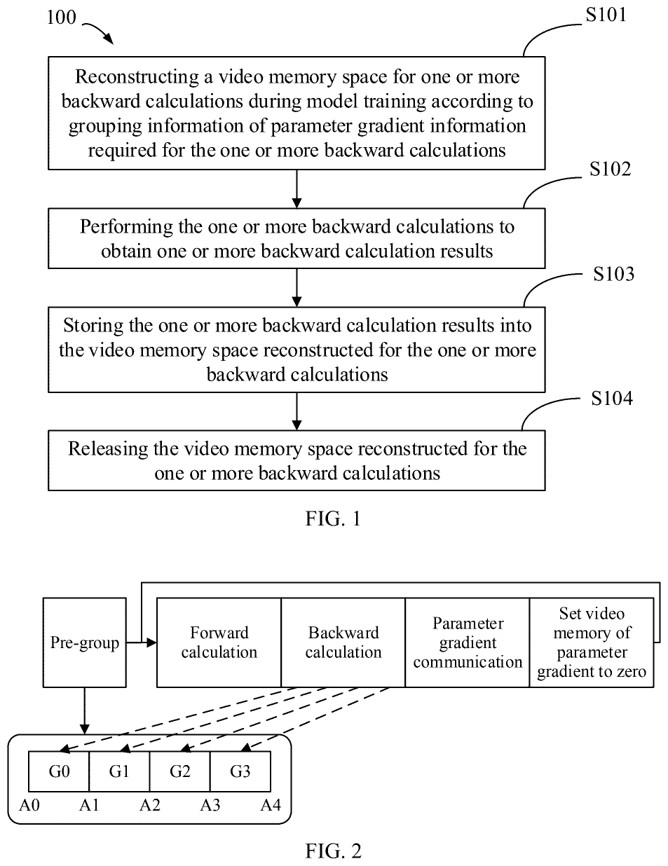

FIG. 1 is a schematic flow chart of a method 100 for controlling a video memory for model training according to an embodiment of the present disclosure. In one implementation, the method includes:
S101: reconstructing a video memory space for one or more backward calculations during model training according to grouping information of parameter gradient information required for the one or more backward calculations;
S102: performing the one or more backward calculations to obtain one or more backward calculation results;
S103: storing the one or more backward calculation results into the video memory space reconstructed for the one or more backward calculations; and
S104: releasing the video memory space reconstructed for the one or more backward calculations.

In the embodiment of the present disclosure, the training process of a model, such as a large model, may include a plurality of training steps. For example, each process of calculating the gradient based on a batch of data and using the gradient to update the model parameters can be regarded as one training step. One training step may include operations forward calculation, backward calculation, parameter gradient communication and other operations. During the parameter gradient communication process, the value of the parameter gradient obtained by the backward calculation needs to be sent from the video memory to a target device such as an internal memory, another video memory, another computer, etc. In order to improve the communication efficiency, the parameter gradient information may be grouped, and a continuous video memory space may be allocated to each group. There are many ways to group. For example, the parameter gradient information involved in one or more layers is grouped together in accordance with layers of the model. For another example, the parameter gradient information is grouped in accordance with various factors such as computing task, computing resource and data distribution of the model.

During the communication process, the data of one or more groups in continuous video memory spaces may be sent together, thereby improving the communication efficiency. For example, as shown in FIG. 2, before training starts, the parameter gradient information G0, G1, G2 and G3 are grouped together in advance; and G0, G1, G2 and G3 and values thereof are stored in continuous video memory spaces in the video memory. G0, G1, G2 and G3 and values thereof stored continuously in the video memory may be sent together to the internal memory or other storage space. If the parameter gradient information is resident in the video memory during model training, the parameter gradient information in this video memory will not be released, but the value of the parameter gradient will be set to zero before each training step ends. In this case, each parameter gradient information will occupy a portion of the video memory regardless of whether it is used or not, and this part of the video memory cannot be saved to improve the model performance.

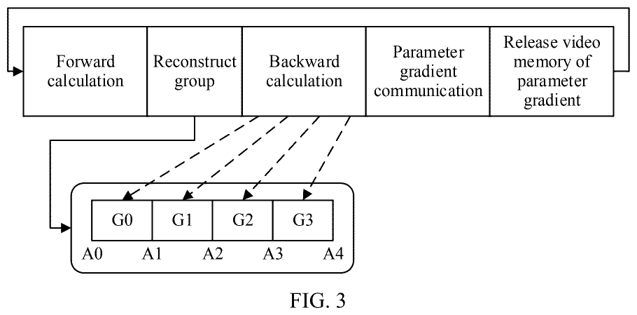

In order to reduce the occupation of the video memory, the grouping information of the parameter gradient information required for one or more backward calculations (or the parameter gradient grouping corresponding to the backward calculations) in the training step may be stored in advance. Before a certain backward calculation needs to be performed, the grouping information of the parameter gradient information required for the backward calculation may be obtained in advance, and a continuous video memory space is reconstructed in the video memory for the parameter gradient information required for the backward calculation (or simply, a video memory space is reconstructed for the backward calculation). As shown in FIG. 3, continuous video memory spaces may be reconstructed for the parameter gradient information G0, G1, G2 and G3 required for the backward calculation, and then the backward calculation is performed, and the backward calculation results are written into the continuous video memory spaces respectively. Here, the backward calculation result of G0 is written into the video memory space corresponding to G0 in the video memory, the backward calculation result of G1 is written into the video memory space corresponding to G1 in the video memory, the backward calculation result of G2 is written into the video memory space corresponding to G2 in the video memory, and the backward calculation result of G3 is written into the video memory space corresponding to G3 in the video memory.

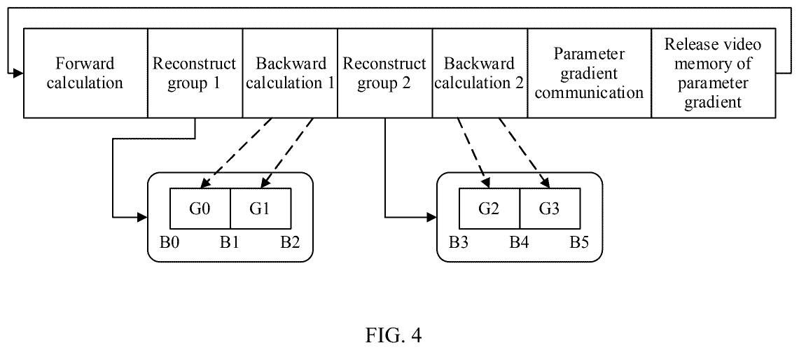

In the embodiment of the present disclosure, if one training step includes only one backward calculation, corresponding video memory spaces may be reconstructed for all elements in the parameter gradient information (for example, the identification information of the parameter gradient) required for the backward calculation before the backward calculation. If one training step includes multiple backward calculations, different backward calculations have their own required parameter gradient information, and the parameter gradient information required for each backward calculation may be grouped together. In one example, before a certain backward calculation is performed, corresponding video memory spaces are reconstructed only for all elements in the grouping information required for this backward calculation. Before a next backward calculation is performed, corresponding video memory spaces are reconstructed only for all elements in the parameter gradient information required for the next backward calculation. As shown in FIG. 4, continuous video memory spaces may be reconstructed for the parameter gradient information G0 and G1 required for the backward calculation 1, then the backward calculation 1 may be performed, and the results of the backward calculation 1 are written into the continuous video memory spaces respectively. Here, the backward calculation result of G0 is written into the video memory space corresponding to G0 in the video memory, and the backward calculation result of G1 is written into the video memory space corresponding to G1 in the video memory. Then, continuous video memory spaces are reconstructed for the parameter gradient information G2 and G3 required for the backward calculation 2, then the backward calculation 2 is performed, and the results of the backward calculation 2 are written into the continuous video memory spaces respectively. Here, the backward calculation result of G2 is written into the video memory space corresponding to G2 in the video memory, and the backward calculation result of G3 is written into the video memory space corresponding to G3 in the video memory.

In the embodiment of the present disclosure, after all backward calculations in one training step are completed, all backward calculation results in the reconstructed video memory spaces may be sent at once during the communication process. After the communication is completed, the reconstructed video memory spaces may be released.

According to the embodiment of the present disclosure, the video memory space can be reconstructed for the parameter gradient information required for the backward calculation before the backward calculation, and the reconstructed video memory space can be released after the backward calculation ends and the model update is completed. The reconstruction, release and other operations take very little time, so the occupancy of the video memory in the subsequent model training process can be reduced, thereby improving the model training speed. Further, since the occupancy of the video memory is reduced in the model training process, there is no need for excessive recalculations, thus reducing the number of recalculations and speeding up the model training process.

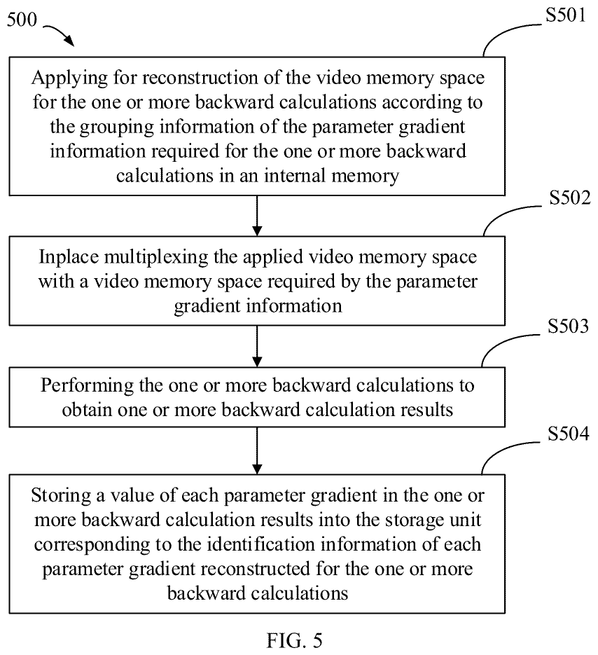

FIG. 5 is a schematic flow chart of a method 500 for controlling a video memory for model training according to another embodiment of the present disclosure. The method 500 may be used to implement step S101 in the method 100 for controlling the video memory for model training. In one implementation, the method 500 includes: reconstructing a video memory space for one or more backward calculations during model training according to grouping information of parameter gradient information required for the one or more backward calculations, further including:
S501: applying for reconstruction of the video memory space for the one or more backward calculations according to the grouping information of the parameter gradient information required for the one or more backward calculations in an internal memory; and
S502: inplace multiplexing the applied video memory space with a video memory space required by the parameter gradient information.

In the embodiment of the present disclosure, the grouping information of the parameter gradient information required for each backward calculation in one training step during model training may be stored in the internal memory in advance. For example, as shown in FIG. 3, the parameter gradient information required for the backward calculation in one training step includes G0, G1, G2 and G3, which belong to a same group. For another example, as shown in FIG. 4, in one training step, the parameter gradient information required for backward calculation 1 includes G0 and G1, which belong to group 1; and the parameter gradient information required for backward calculation 2 includes G2 and G3, which belong to group 2. Before the backward calculation is performed, the reconstruction of the video memory space may be applied according to the grouping information of the parameter gradient information required for the backward calculation in the internal memory. For example, as shown in FIG. 3, for the backward calculation, the video memory space applied for G0 in the grouping information is the address range [A0, A1), the video memory space applied for G1 is the address range [A1, A2), the video memory space applied for G2 is the address range [A2, A3), and the video memory space applied for G3 is the address range [A3, A4). For another example, as shown in FIG. 4, for the backward calculation 1, the video memory space applied for G0 in group 1 is the address range [B0, B1), and the video memory space applied for G1 in group 1 is the address range [B1, B2). After the video memory space is reconstructed, the backward calculation 1 is performed. Then, for the backward calculation 2, the video memory space applied for G2 in group 2 is the address range [B3, B4), and the video memory space applied for G3 in group 2 is the address range [B4, B5). After the video memory space is reconstructed, the backward calculation 2 is performed.

In the embodiment of the present disclosure, the video memory space applied for the backward calculation may be inplace multiplexed with the video memory space of the parameter gradient information required for the backward calculation. Through inplace multiplexing, each parameter gradient information in the grouping information has a corresponding video memory space in the video memory. For example, as shown in FIG. 3 and FIG. 4, the address ranges of the video memory space applied for G0 in the video memory pointed to by G0 are [A0, A1) and [B0, B1) respectively, and the address ranges of the video memory space applied for G1 in the video memory pointed to by G1 are [A1, A2) and [B1, B2) respectively. As shown in FIG. 3 and FIG. 4, the address ranges of the video memory space applied for G2 in the video memory pointed to by G2 are [A2, A3) and [B3, B4) respectively, and the address ranges of the video memory space applied for G3 in the video memory pointed to by G3 are [A3, A4) and [B4, B5) respectively.

In the embodiment of the present disclosure, the video memory spaces reconstructed for the same group are usually continuous. The video memory spaces reconstructed for different groups may be continuous or discontinuous. For example, in FIG. 4, the video memory spaces corresponding to G0, G1, G2 and G3 may be continuous in one case. In another case, the video memory spaces corresponding to G0 and G1 are continuous, the video memory spaces corresponding to G2 and G3 are continuous, but the video memory spaces corresponding to G1 and G2 are not continuous.

After applying for video memory spaces and performing inplace multiplexing as described above, the video memory spaces may be reconstructed for the parameter gradient information required for the backward calculation. Then, after the backward calculation is performed, the backward calculation results may be stored into the corresponding reconstructed video memory spaces respectively. For example, as shown in FIG. 3 and FIG. 4, the backward calculation result of G0 is written into the video memory space [A0, A1) or [B0, B1) corresponding to G0 in the video memory, the backward calculation result of G1 is written into the video memory space [A1, A2) or [B1, B2) corresponding to G1 in the video memory, the backward calculation result of G2 is written into the video memory space [A2, A3) or [B3, B4) corresponding to G2 in the video memory, and the backward calculation result of G3 is written into the video memory space [A3, A4) or [B4, B5) corresponding to G3 in the video memory. In the subsequent communication process, the data in the video memory spaces [A0, A4) or [B0, B2) and [B3, B5) may be sent to the target device together.

According to the embodiment of the present disclosure, the video memory space required for the corresponding parameter gradient information may be reconstructed for each backward calculation, and the parameter gradient information does not need to occupy the video memory space all the time, thus reducing the occupancy of the video memory, saving resources of the video memory, and accelerating the model training process.

In the embodiment of the present disclosure, based on the identification information of multiple parameter gradients in the grouping information of the parameter gradient information required for a certain backward calculation, a video memory space with continuous addresses may be applied in the video memory as the entire video memory space for the grouping information. For example, as shown in FIG. 3, the grouping information includes {parameter gradient G0, parameter gradient G1, parameter gradient G3 , parameter gradient G4} ; where G0, G1, G3 and G4 can be understood as examples of the identification information of parameter gradients. Before the backward calculation is performed, the address range applied for the parameter gradient information in the video memory is [A0, A4). As shown in FIG. 4, the group 1 includes {parameter gradient G0, parameter gradient G1}; and the group 2 includes {parameter gradient G2, parameter gradient G3}. Before the backward calculation 1 is performed, the address range applied for the parameter gradient information in group 1 in the video memory is [B0, B2), and the address range applied for the parameter gradient information in group 2 in the video memory is [B3, B5).

According to the embodiment of the present disclosure, the corresponding video memory spaces can be reconstructed for different backward calculations in the video memory according to the grouping information of the identification information of the parameter gradients required for the backward calculations, the storage spaces can be provided for the backward calculation results, and the reconstructed video memory spaces can be released after the training step is completed, thereby reducing the occupancy of the video memory spaces and accelerating the overall training process.

In one implementation, S502 further includes: inplace multiplexing a storage unit required by identification information of each parameter gradient in the parameter gradient information with the applied video memory space to obtain a storage unit corresponding to the identification information of each parameter gradient in the video memory.

In the embodiment of the present disclosure, after applying for a continuous video memory space for the certain group information, the storage unit required for the identification information of each parameter gradient in the group information may be inplace multiplexed with the continuous video memory space, so that the identification information of each parameter gradient has a corresponding storage unit in the video memory. For example, as shown in FIG. 3 and FIG. 4, inplace multiplexing is performed according to the identification information G0 of the parameter gradient, and G0 may be pointed to the address range [A0, A1) or [B0, B1) of the applied video memory space; inplace multiplexing is performed according to the identification information G1 of the parameter gradient, and G1 may be pointed to the address range [A1, A2) or [B1, B2) of the applied video memory space; inplace multiplexing is performed according to the identification information G2 of the parameter gradient, and G2 may be pointed to the address range [A2, A3) or [B3, B4) of the applied video memory space; inplace multiplexing is performed according to the identification information G3 of the parameter gradient, and G3 may be pointed to the address range [A3, A4) or [B4, B5) of the applied video memory space.

According to the embodiment of the present disclosure, a corresponding storage unit may be reconstructed in the video memory for the identification information of each parameter gradient in the parameter gradient information and is used to store the calculation result of the backward calculation that requires the parameter gradient information, and the storage unit reconstructed in the video memory may be released subsequently to reduce the occupation of the video memory space, provide more video memory space for subsequent model training, and accelerate the overall model training process.

In one implementation, as shown in FIG. 5, the method 500 may also be used to implement step S102 in the method 100 for controlling the video memory for model training. In one implementation, the method 500 may include S503: performing the one or more backward calculations to obtain one or more backward calculation results.

In one implementation, the method 500 may also be used to implement step S103 in the method 100 for controlling the video memory for model training. The method 500 may include: storing the one or more backward calculation results into the video memory space reconstructed for the one or more backward calculations, further including:

S504: storing a value of each parameter gradient in the one or more backward calculation results into the storage unit corresponding to the identification information of each parameter gradient reconstructed for the one or more backward calculations.

In the embodiment of the present disclosure, the value of each parameter gradient in the parameter gradient information corresponding to the backward calculation may be generated during the backward calculation process. These values may be generated sequentially, for example, first the value of G0 and then the value of G1 are generated. By storing the grouping information of the parameter gradient information into the internal memory in advance, the video memory space corresponding to each parameter gradient information in the grouping information may be reconstructed according to the need of the backward calculation. Then the calculated value of each parameter gradient is written into the reconstructed video memory space of each parameter gradient information in the process of performing the backward calculation. For example, after the value V0 of G0 is obtained by backward calculation, V0 is written into the video memory space corresponding to G0. Then the backward calculation is continued. After the value V1 of G1 is obtained, V1 is written into the video memory space corresponding to G1.

According to the embodiment of the present disclosure, the value of each parameter gradient obtained by backward calculation can be stored in the reconstructed video memory space, and the communication efficiency with other devices or components can be improved through the continuous video memory space. In addition, the reconstructed storage unit in the video memory can be released later, reducing the occupation of the video memory space and improving the model training speed.

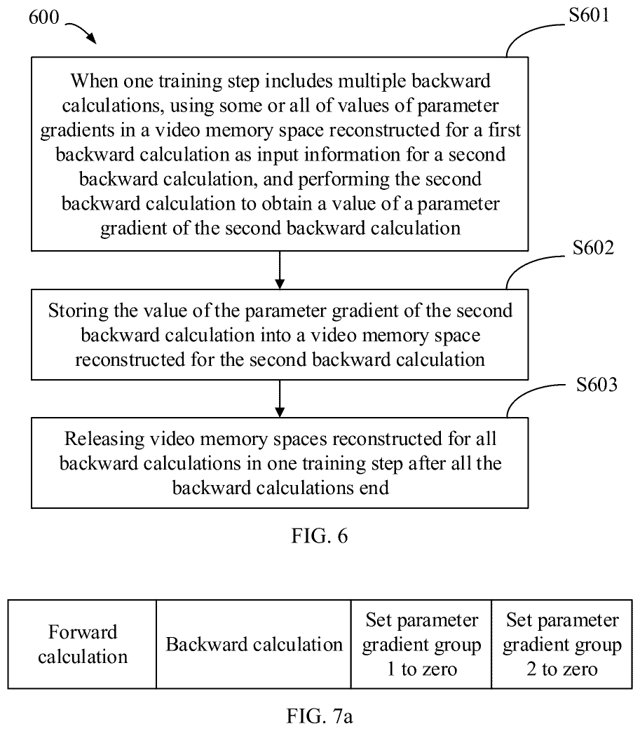

FIG. 6 is a schematic flow chart of a method 600 for controlling a video memory for model training according to another embodiment of the present disclosure. The method 600 may be used to implement step S102 in the method 100 for controlling the video memory for model training. In one implementation, the method 600 may include: performing the one or more backward calculations to obtain one or more backward calculation results, further including:

S601: when one training step includes multiple backward calculations, using some or all of values of parameter gradients in a video memory space reconstructed for a first backward calculation as input information for a second backward calculation, and performing the second backward calculation to obtain a value of a parameter gradient of the second backward calculation.

In the embodiment of the present disclosure, there may be an association relationship among multiple backward calculations included in one training step. It is assumed that one training step includes a first backward calculation and a second backward calculation, and some or all of values of parameter gradients in the calculation result of the first backward calculation may be used in the second backward calculation. In this case, the video memory space may be reconstructed for the first backward calculation first; and the first backward calculation is performed to obtain the first backward calculation result (the values of the parameter gradients). Then some or all of the values of the parameter gradients obtained by the first backward calculation are used as inputs of the second backward calculation, and the second backward calculation is continued.

In the embodiment of the present disclosure, if there is no association among multiple backward calculations in one training step, these backward calculations may be independently directed to S101 to S103, and then S104 is executed to delete the values of the parameter gradients obtained by these backward calculations in the video memory, thereby releasing the video memory spaces reconstructed for these backward calculations.

According to the embodiment of the present disclosure, the values of the parameter gradients obtained by the previous backward calculation can be used as inputs of the next backward calculation, reducing the number of recalculations and improving the training efficiency.

In one implementation, as shown in FIG. 6, the method 600 may also be used to implement step S103 in the method 100 for controlling the video memory for model training. In one implementation, the method 600 further include: storing the one or more backward calculation results into the video memory space reconstructed for the one or more backward calculations, further including:

S602: storing the value of the parameter gradient of the second backward calculation into a video memory space reconstructed for the second backward calculation.

In the embodiment of the present disclosure, it is assumed that there is an association relationship between the first backward calculation and the second backward calculation included in one training step, and some or all of values of parameter gradients in the calculation result of the first backward calculation may be used in the second backward calculation. In this case, S101 to S103 may be executed first for the first backward calculation: reconstructing a video memory space for the first backward calculation according to the first grouping information of the parameter gradient information required for the first backward calculation; performing the first backward calculation to obtain a first backward calculation result; and storing the first backward calculation result into the video memory space reconstructed for the first backward calculation. Then, some or all of values of parameter gradients obtained by the first backward calculation are used as inputs of the second backward calculation, and S101 to S103 are executed for the second backward calculation: a video memory space is reconstructed for the second backward calculation according to the second grouping information of the parameter gradient information required for the second backward calculation; performing the second backward calculation to obtain a second backward calculation result; and storing the second backward calculation result into the video memory space reconstructed for the second backward calculation.

In one example, referring to FIG. 4, the first backward calculation is backward calculation 1, and the second backward calculation is backward calculation 2. The video memory spaces [B0, B1) and [B1, B2) are reconstructed for the backward calculation 1 according to the first grouping information of the parameter gradient information G0 and G1 required for the first backward calculation in the model training process; the backward calculation 1 is performed to obtain the results V0 and V1 of the backward calculation 1; and the results of the backward calculation 1 are stored into the video memory spaces reconstructed for the first backward calculation, that is, V0 is stored into [B0, B1) and V1 is stored into [B1, B2). If the backward calculation 2 requires the value V1 of G1, the value V1 of G1 may be used as the input of the backward calculation 2. The video memory spaces [B3, B4) and [B4, B5) are reconstructed for the backward calculation 2 according to the second grouping information of the parameter gradient information G1 and G2 required for the backward calculation 2; the backward calculation 2 is performed to obtain the results V2 and V3 of the backward calculation 2; and the results of the backward calculation 2 are stored into the video memory spaces reconstructed for the backward calculation 2, that is, V2 is stored into [B3, B4) and V3 is stored into [B4, B5).

According to the embodiment of the present disclosure, the video memory space is reconstructed for the parameter gradient information required for the second backward calculation before each backward calculation in the model training process, and the reconstructed video memory space is released after all backward calculations in the model training process end and the model update is completed, thus reducing the occupancy of the video memory space in the model training process, and improving the model training speed.

In one implementation, as shown in FIG. 6, the method 600 may also be used to implement step S104 in the method 100 for controlling the video memory for model training. In one implementation, the method 600 further includes: releasing the video memory space reconstructed for the one or more backward calculations, further including:

S603: releasing video memory spaces reconstructed for all backward calculations in one training step after all the backward calculations end.

In the embodiment of the present disclosure, if one training step includes multiple backward calculations and the video memory space has been reconstructed for each backward calculation, the video memory spaces of all backward calculations designed for the training step can be released after the training step is completed. As shown in FIG. 4, the video memory spaces [B0, B2) and [B3, B5) reconstructed for the backward calculation 1 and backward calculation 2 may be released. During release, the reconstructed video memory space may be unloaded from the video memory, or the data in the reconstructed video memory space may be deleted. When a new batch of samples is used for the next training step, a video memory space may be reconstructed for the grouping information of the parameter gradient information required for the backward calculation in the next training step, and the backward calculation may be performed. Also, the reconstructed video memory space may be released when each training step ends.

According to the embodiment of the present disclosure, since the time required for the process of reconstructing and releasing the video memory space is very short but the unnecessary occupation of the video memory space during the training process can be greatly reduced, the overall training speed can be improved.

The recalculation strategy is a common strategy in large model training, and can reduce the occupation of the video memory during the model training process and ensure that the model can be trained under the constraint of the limited video memory space. During the training process of a large model, when certain conditions are triggered, specific calculations may be re-performed through the recalculation strategy so that the model can be trained. However, the recalculation itself introduces redundant calculations, resulting in additional performance loss. In order to reduce the performance loss of recalculation, it is necessary to explore ways to optimize the video memory and reduce the peak occupation of the video memory during model training, so as to partially or completely shut down the recalculation and improve the model performance.

The optimization of the video memory of the parameter gradients is an important optimization direction. In related technical solutions, the parameter gradients are often fused into tensors of one or more continuous video memory spaces to improve the communication performance of the parameter gradients during data parallel training, but this makes it difficult to release the video memory of the parameter gradients and makes it impossible to optimize the video memory of the parameter gradients.

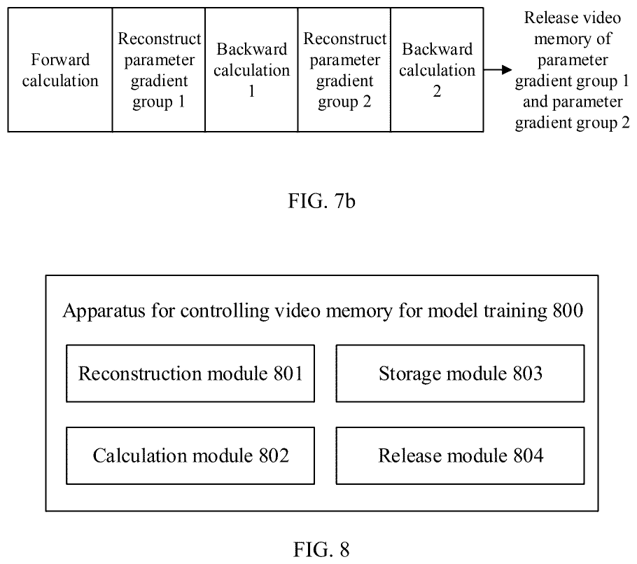

Before the model training begins, all parameter gradients may be grouped, and all parameter gradients in each group may be fused into a large tensor to improve the communication performance of the parameter gradients. If the parameter gradients are resident in the video memory during the model training process, the parameter gradients in the video memory will not be released, but the values of the parameter gradients will be set to 0, as shown in FIG. 7a. In this case, each parameter gradient will occupy a portion of the video memory regardless of whether it is used or not, and this part of the video memory cannot be saved to improve the model performance.

In one example, as shown in FIG. 2, the parameter gradients are divided into two groups. During the actual model training process, after the backward calculations in the current training step are performed, the zeroing operation needs to be performed on the parameter gradient group 1 and the parameter gradient group 2 before the next training step can be carried out. The peak of the video memory during the training process occurs after the forward calculation is completed and before the backward calculation begins. Referring to FIG. 2, the parameter gradient group 1 includes G0 and G1, and the parameter gradient group 2 includes G2 and G3. After the backward calculation in one training step is completed, the backward calculation results corresponding to G0, G1, G2 and G3 will be set to zero, but the video memory spaces corresponding to G0, G1, G2 and G3 will be retained in the video memory. In the next training step, the video memory spaces corresponding to G0, G1, G2 and G3 are still used to store respective backward calculation results.

The embodiment of the present disclosure may adopt a dynamic gradient release method to release the model parameter gradients from the video memory after each batch of training is completed. During the backward calculation, dynamic reconstruction is performed according to the grouping information to meet the video memory requirement of the backward calculation. This embodiment can reduce the overall occupancy of the video memory of the model, thereby reducing the occupancy of the video memory by recalculations and improving the training performance of the large model.

As shown in FIG. 7b, the video memory of all parameter gradient groups may be released after each training step ends. When the backward calculation needs to be performed on a certain parameter gradient, the parameter gradient group to which this parameter gradient belongs may be reconstructed, and the video memory space of this group may be applied for. The information (e.g., the grouping information of the parameter gradient information) required for the reconstruction process is recorded in the internal memory before training begins. The reconstruction process mainly includes two operations: one operation is to apply for the video memory space of the group to be reconstructed according to the group information of the parameter gradient information in the internal memory; and the other operation is to inplace multiplex the video memory space of the parameter gradient information in the grouping information generated by the backward operator of the backward calculation with the video memory space applied for the grouping information. For example, the name of the parameter gradient in the grouping information is pointed to the reconstructed video memory space corresponding to the name of the parameter gradient in the video memory through a pointer. The time spent on these two operations in the reconstruction process is almost negligible. As shown in FIG. 7b, after the video memory space 1 is reconstructed for the parameter gradient group 1 required for the backward calculation 1, the backward calculation 1 may be performed, and the calculation results of the backward calculation 1 are respectively stored in the corresponding positions in the reconstructed video memory space 1. After the video memory space 2 is reconstructed for the parameter gradient group 2 required for the backward calculation 2, the backward calculation 2 may be performed, and the calculation results of the backward calculation 2 are respectively stored in the corresponding positions in the reconstructed video memory space 2.

In one example, referring to FIG. 4, the calculation results of G0 and G1 obtained by the backward calculation 1 are respectively stored into the storage unit of G0 and the storage unit of G1 in the reconstructed video memory space. The calculation results of G2 and G3 obtained by the backward calculation 2 are respectively stored into the storage unit of G2 and the storage unit of G3 in the reconstructed video memory space.

According to the embodiment of the present disclosure, after the forward calculation is completed and before the backward calculation begins, the occupied video memory may not include the video memory of the parameter gradients, thereby reducing the peak occupancy of the video memory. As the peak of the video memory is reduced, there is no need to save the video memory space through too many recalculations, thus further reducing the occupancy of the video memory by recalculations and improving the model training performance. The present disclosure can be applied to the performance optimization of the large model training process that requires the recalculation strategy. The peak occupancy of the video memory of the model is reduced by dynamically releasing and reconstructing the video memory of the parameter gradient, and some recalculations can be turned off to improve the training performance.

FIG. 8 is a structural schematic diagram of an apparatus 800 for controlling a video memory for model training according to an embodiment of the present disclosure. In one implementation, this apparatus includes:
a reconstruction module 801 configured to reconstruct a video memory space for one or more backward calculations during model training according to grouping information of parameter gradient information required for the one or more backward calculations;
a calculation module 802 configured to perform the one or more backward calculations to obtain one or more backward calculation results;
a storage module 803 configured to store the one or more backward calculation results into the video memory space reconstructed for the one or more backward calculations; and
a release module 804 configured to release the video memory space reconstructed for the one or more backward calculations.

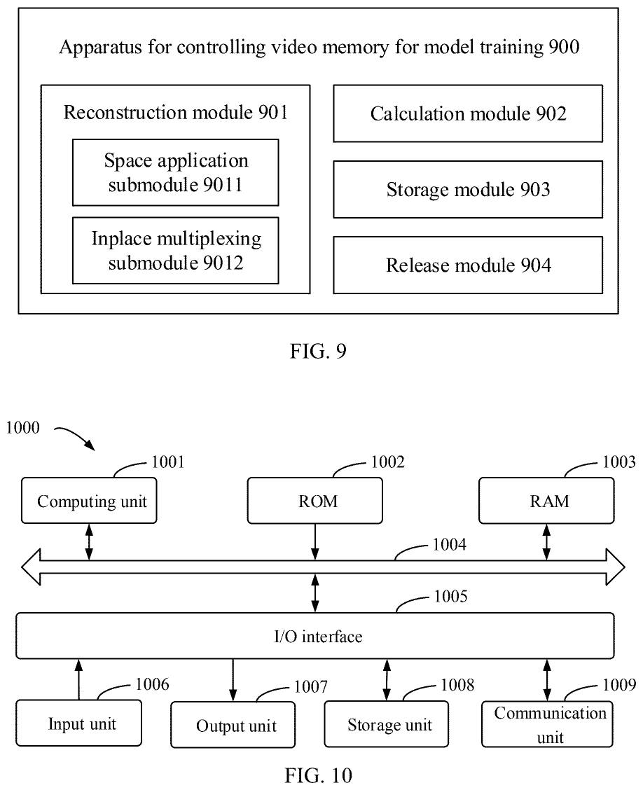

FIG. 9 is a structural schematic diagram of an apparatus 900 for controlling a video memory for model training according to another embodiment of the present disclosure. The apparatus 900 includes: a reconstruction module 901, a calculation module 902, a storage module 903 and a release module 904. The functions of the above modules can refer to the functions of the modules of the apparatus 800 for controlling the video memory for model training in the above embodiment. In one implementation, the reconstruction module 901 includes:
a space application submodule 9011 configured to apply for reconstruction of the video memory space for the one or more backward calculations according to the grouping information of the parameter gradient information required for the one or more backward calculations in an internal memory; and
an inplace multiplexing submodule 9012 configured to inplace multiplex the applied video memory space with the grouping information of the parameter gradient information in the internal memory.

In one implementation, the inplace multiplexing submodule 9012 is further configured to inplace multiplex a storage unit required by identification information of each parameter gradient in the parameter gradient information with the applied video memory space to obtain a storage unit corresponding to the identification information of each parameter gradient in the internal memory in the video memory.

In one implementation, the storage module 903 is further configured to store a value of each parameter gradient in the one or more backward calculation results into the storage unit corresponding to the identification information of each parameter gradient reconstructed for the one or more backward calculations.

In one implementation, the calculation module 902 is further configured to, when one training step includes multiple backward calculations, use some or all of values of parameter gradients in a video memory space reconstructed for a first backward calculation as input information for a second backward calculation, and perform the second backward calculation to obtain a value of a parameter gradient of the second backward calculation.

In one implementation, the storage module 903 is further configured to store the value of the parameter gradient of the second backward calculation into a video memory space reconstructed for the second backward calculation.

In one implementation, the release module 904 is further configured to release video memory spaces reconstructed for all backward calculations in one training step after all the backward calculations end.

For the description of specific functions and examples of the modules and sub-modules of the apparatus of the embodiment of the present disclosure, reference may be made to the relevant description of the corresponding steps in the above-mentioned method embodiments, and details are not repeated here.

In the technical solution of the present disclosure, the acquisition, storage and application of the user's personal information involved are in compliance with relevant laws and regulations, and do not violate public order and good customs.

According to the embodiments of the present disclosure, the present disclosure also provides an electronic device, a readable storage medium and a computer program product.

FIG. 10 shows a schematic block diagram of an exemplary electronic device 1000 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 10, the device 1000 includes a computing unit 1001 that may perform various appropriate actions and processes according to a computer program stored in a Read-Only Memory (ROM) 1002 or a computer program loaded from a storage unit 1008 into a Random Access Memory (RAM) 1003. Various programs and data required for an operation of device 1000 may also be stored in the RAM 1003. The computing unit 1001, the ROM 1002 and the RAM 1003 are connected to each other through a bus 1004. The input/output (I/O) interface 1005 is also connected to the bus 1004.

A plurality of components in the device 1000 are connected to the I/O interface 1005, and include an input unit 1006 such as a keyboard, a mouse, or the like; an output unit 1007 such as various types of displays, speakers, or the like; the storage unit 1008 such as a magnetic disk, an optical disk, or the like; and a communication unit 1009 such as a network card, a modem, a wireless communication transceiver, or the like. The communication unit 1009 allows the device 1000 to exchange information/data with other devices through a computer network such as the Internet and/or various telecommunication networks.

The computing unit 1001 may be various general-purpose and/or special-purpose processing components with processing and computing capabilities. Some examples of the computing unit 1001 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 1001 performs various methods and processes described above, such as the method for controlling the video memory for model training. For example, in some implementations, the method for controlling the video memory for model training may be implemented as a computer software program tangibly contained in a computer-readable medium, such as the storage unit 1008. In some implementations, a part or all of the computer program may be loaded and/or installed on the device 1000 via the ROM 1002 and/or the communication unit 1009. When the computer program is loaded into RAM 1003 and executed by the computing unit 1001, one or more steps of the method for controlling the video memory for model training described above may be performed. Alternatively, in other implementations, the computing unit 1001 may be configured to perform the method for controlling the video memory for model training by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method for controlling a video memory for model training, comprising:
reconstructing a video memory space for one or more backward calculations during model training according to grouping information of parameter gradient information required for the one or more backward calculations;
performing the one or more backward calculations to obtain one or more backward calculation results;
storing the one or more backward calculation results into the video memory space reconstructed for the one or more backward calculations; and
releasing the video memory space reconstructed for the one or more backward calculations.

2. The method of claim 1, wherein reconstructing a video memory space for one or more backward calculations during model training according to grouping information of parameter gradient information required for the one or more backward calculations, comprises:
applying for reconstruction of the video memory space for the one or more backward calculations according to the grouping information of the parameter gradient information required for the one or more backward calculations in an internal memory; and
inplace multiplexing the applied video memory space with a video memory space required by the parameter gradient information.

3. The method of claim 2, wherein inplace multiplexing the applied video memory space with a video memory space required by the parameter gradient information, comprises:
inplace multiplexing a storage unit required by identification information of each parameter gradient in the parameter gradient information with the applied video memory space to obtain a storage unit corresponding to the identification information of each parameter gradient in the video memory.

4. The method of claim 3, wherein storing the one or more backward calculation results into the video memory space reconstructed for the one or more backward calculations, comprises:
storing a value of each parameter gradient in the one or more backward calculation results into the storage unit corresponding to the identification information of each parameter gradient reconstructed for the one or more backward calculations.

5. The method of claim 1, wherein performing the one or more backward calculations to obtain one or more backward calculation results, comprises:
in a case of one training step comprises multiple backward calculations, using some or all of values of parameter gradients in a video memory space reconstructed for a first backward calculation as input information for a second backward calculation, and performing the second backward calculation to obtain a value of a parameter gradient of the second backward calculation.

6. The method of claim 5, wherein storing the one or more backward calculation results into the video memory space reconstructed for the one or more backward calculations, comprises:
storing the value of the parameter gradient of the second backward calculation into a video memory space reconstructed for the second backward calculation.

7. The method of claim 1, wherein releasing the video memory space reconstructed for the one or more backward calculations, comprises:
releasing video memory spaces reconstructed for all backward calculations in one training step after all the backward calculations end.

8. An electronic device, comprising:
at least one processor; and
a memory connected in communication with the at least one processor;
wherein the memory stores an instruction executable by the at least one processor, and the instruction, when executed by the at least one processor, enables the at least one processor to execute:
reconstructing a video memory space for one or more backward calculations during model training according to grouping information of parameter gradient information required for the one or more backward calculations;
performing the one or more backward calculations to obtain one or more backward calculation results;
storing the one or more backward calculation results into the video memory space reconstructed for the one or more backward calculations; and
releasing the video memory space reconstructed for the one or more backward calculations.

9. The electronic device of claim 8, wherein the instruction, when executed by the at least one processor, enables the at least one processor to execute reconstructing a video memory space for one or more backward calculations during model training according to grouping information of parameter gradient information required for the one or more backward calculations, by:
applying for reconstruction of the video memory space for the one or more backward calculations according to the grouping information of the parameter gradient information required for the one or more backward calculations in an internal memory; and
inplace multiplexing the applied video memory space with a video memory space required by the parameter gradient information.

10. The electronic device of claim 9, wherein the instruction, when executed by the at least one processor, enables the at least one processor to execute inplace multiplexing the applied video memory space with a video memory space required by the parameter gradient information, by:
inplace multiplexing a storage unit required by identification information of each parameter gradient in the parameter gradient information with the applied video memory space to obtain a storage unit corresponding to the identification information of each parameter gradient in the video memory.

11. The electronic device of claim 10, wherein the instruction, when executed by the at least one processor, enables the at least one processor to execute storing the one or more backward calculation results into the video memory space reconstructed for the one or more backward calculations, by:
storing a value of each parameter gradient in the one or more backward calculation results into the storage unit corresponding to the identification information of each parameter gradient reconstructed for the one or more backward calculations.

12. The electronic device of claim 8, wherein the instruction, when executed by the at least one processor, enables the at least one processor to execute performing the one or more backward calculations to obtain one or more backward calculation results, by:
in a case of one training step comprises multiple backward calculations, using some or all of values of parameter gradients in a video memory space reconstructed for a first backward calculation as input information for a second backward calculation, and performing the second backward calculation to obtain a value of a parameter gradient of the second backward calculation.

13. The electronic device of claim 12, wherein the instruction, when executed by the at least one processor, enables the at least one processor to execute storing the one or more backward calculation results into the video memory space reconstructed for the one or more backward calculations, by:
storing the value of the parameter gradient of the second backward calculation into a video memory space reconstructed for the second backward calculation.

14. The electronic device of claim 8, wherein the instruction, when executed by the at least one processor, enables the at least one processor to execute releasing the video memory space reconstructed for the one or more backward calculations, by:
releasing video memory spaces reconstructed for all backward calculations in one training step after all the backward calculations end.

15. A non-transitory computer-readable storage medium storing a computer instruction thereon, wherein the computer instruction is used to cause a computer to execute:
reconstructing a video memory space for one or more backward calculations during model training according to grouping information of parameter gradient information required for the one or more backward calculations;
performing the one or more backward calculations to obtain one or more backward calculation results;
storing the one or more backward calculation results into the video memory space reconstructed for the one or more backward calculations; and
releasing the video memory space reconstructed for the one or more backward calculations.

16. The non-transitory computer-readable storage medium of claim 15, wherein the computer instruction is used to cause the computer to execute reconstructing a video memory space for one or more backward calculations during model training according to grouping information of parameter gradient information required for the one or more backward calculations, by:
applying for reconstruction of the video memory space for the one or more backward calculations according to the grouping information of the parameter gradient information required for the one or more backward calculations in an internal memory; and
inplace multiplexing the applied video memory space with a video memory space required by the parameter gradient information.

17. The non-transitory computer-readable storage medium of claim 16, wherein the computer instruction is used to cause the computer to execute inplace multiplexing the applied video memory space with a video memory space required by the parameter gradient information, by:
inplace multiplexing a storage unit required by identification information of each parameter gradient in the parameter gradient information with the applied video memory space to obtain a storage unit corresponding to the identification information of each parameter gradient in the video memory.

18. The non-transitory computer-readable storage medium of claim 17, wherein the computer instruction is used to cause the computer to execute storing the one or more backward calculation results into the video memory space reconstructed for the one or more backward calculations, by:
storing a value of each parameter gradient in the one or more backward calculation results into the storage unit corresponding to the identification information of each parameter gradient reconstructed for the one or more backward calculations.

19. The non-transitory computer-readable storage medium of claim 15, wherein the computer instruction is used to cause the computer to execute performing the one or more backward calculations to obtain one or more backward calculation results, by:
in a case of one training step comprises multiple backward calculations, using some or all of values of parameter gradients in a video memory space reconstructed for a first backward calculation as input information for a second backward calculation, and performing the second backward calculation to obtain a value of a parameter gradient of the second backward calculation.

20. The non-transitory computer-readable storage medium of claim 19, wherein the computer instruction is used to cause the computer to execute storing the one or more backward calculation results into the video memory space reconstructed for the one or more backward calculations, by:
storing the value of the parameter gradient of the second backward calculation into a video memory space reconstructed for the second backward calculation.
